(19) United States
(12) Patent Application Publication
(10) Pub. No.: US 2009/0249663 A1
(43) Pub. Date: Oct. 8, 2009

(54) Calendar/Paperweight

(75) Inventor: Jose Maria Tomas Reyne, Valls (Tarragona) (ES)

Correspondence Address: RICHARD M. GOLDBERG, 25 EAST SALEM STREET, SUITE 419, HACKENSACK, NJ, 07601, US

(73) Assignee: FUNMAK, S.L., Valls (Tarragona) (ES)

(21) Appl. No.: 12/096,225

(22) PCT Filed: Dec. 13, 2006
(86) PCT No.: PCT/ES2006/000689

§ 371 Date: Jun. 5, 2008

(30) Foreign Application Priority Data
Dec. 30, 2005 (ES) U200600041

(51) Int. Cl. G09D 3/06

(52) U.S. Cl. 40/119

(57) ABSTRACT

A calendar/paperweight includes a cardboard support including two metal rules provided on the base of the support on either side of the central line along which the base is folded. The rules are positioned symmetrically along the lower edges of the side walls of the support, so as not to interfere with the sheets of the calendar. The tubular support takes the form of an isosceles triangle that can be folded. The upper edge of the support is provided with a spiral for connecting a plurality of sheets which include blank squares corresponding to different days for annotations which can be written on the calendar. The sheets can be positioned indiscriminately onto both the front and rear faces of the support. Metal rules are fixed to the support such as to considerably increase the weight of the calendar and, to improve the stability thereof.

### OBJECT OF INVENTION

The former invention refers to a sort of calendars that are constituted by a support of triangular profile, generally made of cardboard, destined to stand on a horizontal surface such as a table, provided in correspondence with its upper edge a bobbin functioning as a tilting spindle for the calendar sheets of paper that, superposed in its fronting side, are capable to be tilt toward its backside.

The aim of this invention is to achieve a table-calendar with a higher degree of stability, susceptible of being used as a paperweight simultaneously.

It is another aim of this invention the fact that, on the sort of calendar stipulated previously, normally lacking stability, notes can be taken in any of the days marked on the sheets of paper.

In the common calendars previously cited, the support of triangular profile, generally made of cardboard, includes in its base a folding line to minimize the volume of the calendar when it is not to be used or displayed, and with an isoscelic profile which receives through the bobbin on the upper edge, the notepad calendar, which is usually and substantially shorter than the sides of the support on which it lies, leaving a wide strip under it that is often fulfilled with pieces of advertisement.

This type of calendars present a problem focused mainly in two aspects:
in one hand, the lightness of its material, which is basically paper, and its collapsible support, make the whole calendar have the minimum stability, so that it can hardly stand on a table or set place, and
in the other hand, as a consequence of this lack of stability, it is almost impossible to take notes in the calendar, because the minimum pressure needed to take them is enough to make the feeble calendar to overturn. That is the reason why the type of calendars focused are not provided blank areas in their sheets.

### DESCRIPTION OF THE INVENTION

The paperweight-calendar suggested solves satisfactorily the problem above argued. Thanks to its special structure it fulfils the increase of weight in such a way that its stability turn out to be possible on a table or any other surface, what in one hand makes it feasible to take notes on the sheets of paper without peril of tumble, and in the other hand, it allows the calendar to be used as a paperweight at the same time.

To that effect, the calendar advocated, starting from the basic structure of the common calendar of the type above cited, centres its characteristics in the fact that the inferior strips of the lateral walls of its support, the ones not affected by the calendar sheets and commonly destined to the advertisement, include two guides, for instance made of steel or any other material or combination of heavy materials, even metal injected with plastic, which add to the calendar the weight needed to become perfectly stable on a given surface and to be used as paper-weight.

The above cited guides can affect in all its height the free strips, or only affect them partially. They can be used as a support to the destined information previously intended to be placed in that part of the support, or even be placed in the base in order to achieve the same stabilizing effect.

As a consequence of the improvement of the support's stability due to the counterweight included, and as a result, the improvement of the calendar as a whole, it is feasible to turn the pages with a single hand, and also to take notes on them. On that purpose, next to each number, a blank square has been marked delimitating a zone for each day of the year so that notes related to that date may be taken.

### DESCRIPTION OF THE PICTURES

To complement the former description and as a help to the comprehension of the characteristics of the invention, according to an example of practical performance of it, a number of pictures are added, as a complementary part of the description, where as a no limitating illustration, it has been depicted:

Picture 1: sample of the sight of a paperweight-calendar in front-lateral perspective, made according to the object of the former invention.

Picture 2: sample of the sight of the frontal elevation of the calendar.

### PREFERABLE PERFORMANCE OF THE INVENTION

At the sight of both pictures, specially picture 1, it can be noticed that the calendar advocated is of the type of those that include a tubular support, of triangular profile, which defines a front side (1), a back side (2) and a base (3), provided of a folding line in the middle (4) that allows the support to adopt the prismatic and triangular configuration of the figure (1), or that it adopts a total plain state, being folded its base (3) in itself and joining the front (1) and back (2) sides, so that the space occupied is the minimum in an ineffective situation.

Besides, this type of common calendars includes, in correspondence to the upper edge, a bobbin or spiral (5) through which the sheets of paper constituting the calendar in itself are fixed with the possibility of being removed from the support of cardboard (6) and being susceptible of being turned individually from the fronting (1) to the back side of the support.

The support includes, preferably fixed to both opposite sides of the support (1-2), two metallic guides (7) or of any other material or combination of materials heavy enough, which, properly disposed, increase the weigh of the calendar providing to it a degree of stability to make it useful as a paperweight as well.

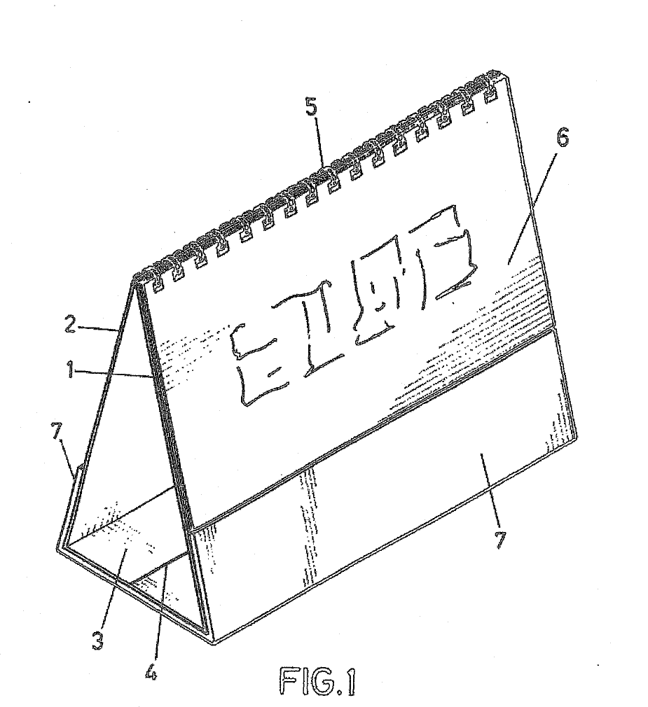

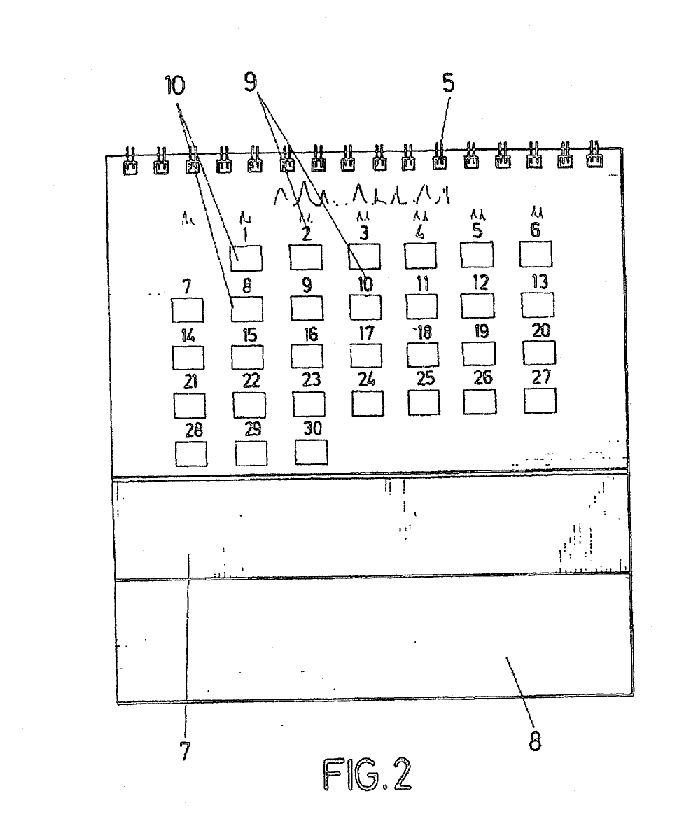

In the habitual cases, as the one represented in the pictures, in which the height of the sheets of paper (6) constituting the calendar is smaller than the sides (1-2) of the support, so that in the inferior part of these sides a wide space remains free in (8) under the notepad, the metallic guides may affect the mentioned spaces wholly, as depicted in FIG. 1, or only affect them partially, as seen in FIG. 2.

If the sheets of paper (6) would reach the lower edge of the side (1-2), the metallic guides (7) may be placed either on the base (3), on both sides of the folding line (4), or maintain them placed on the upper sides that are inclined (1-2) but being fixed in the inside face of them.

It is possible as well to combine the metallic guides placing them simultaneously on the lateral insides (1-2) and base (3) of the support.

In either case the result is empower considerably the stability of the calendar, what far from only allowing the usage as paperweight, as just mentioned, would also allow the former calendar to stand little pressures generated on it when pages are to be turn with the help of a single hand from the user or also when notes are to be taken on its notepad.

In this latter sense it has been designed that, around the numbers (9) identifying each of the days of each month of the year, blank squares (10) are provided for the purpose of receiving handwriting notes.

What is claimed is:

1. Paperweight-calendar, comprising:
a support in the shape of an isosceles triangle, foldable and provided with a spiral at an upper edge thereof as a joint for holding a plurality of sheets of paper which can be moved to both front and back sides of the support, and
rigid guides made of a material fixed to the support, and which material is sufficiently heavy to considerably increase the weight of the paperweight-calendar to enable the paperweight-calendar to function as a paperweight, while also increasing its stability.

2. Paperweight-calendar, according to claim 1 wherein the support includes two symmetrically disposed guides.

3. Paperweight-calendar, according to claim 2 wherein the guides are placed on lateral sides of the support, at positions in a lower free space thereof disposed below the sheets of paper constituting the calendar.

4. Paperweight-calendar, according to claim 2 wherein the support includes a base with a folding line and the guides are provided on the base of the support on both sides of the folding line.

5. Paperweight-calendar, according to claim 2 wherein the support includes a base and the guides are positioned simultaneously on the base and on both lateral sides of the support.

6. Paperweight-calendar, according to claim 1, wherein the sheets of paper have numbers referring to days of each month of a year, and blank squares are provided on the sheets next to each number for each day, for the purpose of adding handwriting notes by a direct pressure on the heavy, stable calendar.

7. Paperweight-calendar, according to claim 1, wherein the tubular support is made of a paperboard material.

8. Paperweight-calendar, according to claim 1, wherein the rigid guides are made from a material selected from the group consisting of a metal and a metal injected with plastic, and steel.

9. Paperweight-calendar, according to claim 5, wherein said rigid guides are formed together as a single, one-piece construction that fits around an outer surface of the base and both lateral sides of the support.

10. Paperweight-calendar, according to claim 5, wherein said rigid guides are formed together as a single, one-piece construction that fits inside an inner surface of the base and both lateral sides of the support.
